(19) United States
(12) Patent Application Publication
(10) Pub. No.: US 2023/0045352 A1
(43) Pub. Date: Feb. 9, 2023

(54) Pre-coated steel sheet comprising an additional coating for increasing the mechanical strength of the weld metal zone of a welded steel part prepared from said pre-coated sheet.

(71) Applicant: ArcelorMittal, Luxembourg (LU)

(72) Inventors: Yunhong (Norman) ZHOU, Waterloo (CA); Dulal Chandra SAHA, Waterloo (CA); Elliot BIRO, Hamilton (CA); Andrew MACWAN, Hamilton (CA); Adrian Piotr GERLICH, Waterloo (CA); Shehryar KHAN, Kitchener (CA)

(21) Appl. No.: 17/787,512

(22) PCT Filed: Dec. 15, 2020
(86) PCT No.: PCT/IB2020/061928

§ 371 Date: Jun. 20, 2022

(30) Foreign Application Priority Data
Dec. 24, 2019 (IB) PCT/IB2019/061333

(51) Int. Cl. B23K 26/24; C23C 2/12; C23C 2/26; C23C 2/20; C23C 28/00

(52) U.S. Cl. CPC B23K 26/24; C23C 2/12; C23C 2/26; C23C 2/20; C23C 28/30; B23K 2101/34

(57) ABSTRACT

A pre-coated steel sheet wherein at least a region at the periphery (7) of at least one (6a,6b) of the opposite faces (6a,6b) of said pre-coated sheet (1,1′) is coated with an additional coating (8) selected for increasing the vapor pressure between the pre-coating (2) and said additional coating (8) during a laser welding method up to a critical pressure at which the pre-coating (2) is ejected away from the weld (14). Preferably, the vaporization temperature of the additional coating (8) is greater than the vaporization temperature of the pre-coating (2) and the additional coating includes gammagene elements like carbon and/or nickel. A steel part obtained by laser welding, preferably butt laser welding, of at least a first and second pre-coated steel sheet (1,1′) as above indicated is also provided.

The present invention relates principally to a pre-coated steel sheet comprising an additional coating for increasing the mechanical strength of the weld metal zone of a welded steel part prepared from said pre-coated sheet.

The present invention also relates to a method for the fabrication of said pre-coated steel sheet.

The present invention further relates to a steel part obtained by laser welding of at least a first and second pre-coated steel sheet comprising an additional coating for increasing the mechanical strength of the weld metal zone of the welded steel part.

The present invention finally relates to a method for the fabrication of said steel part.

### BACKGROUND

The prior art discloses methods for the fabrication of welded steel parts from steel blanks of different compositions and/or thicknesses that are continuously butt-welded to one another. In a first known fabrication mode, these welded blanks are cold-formed. In a second known fabrication mode, these welded blanks are heated to a temperature that makes possible the austenitization of the steel and are then hot-formed and rapidly cooled in the forming die. This invention relates to this second fabrication mode.

The composition of the steel can be selected both to make possible subsequent heating and forming operations and to give the welded steel part high mechanical strength, high impact strength and good corrosion resistance.

In recent years, boron containing press-hardened steels (PHS) have gained attention among automakers due to the excellent ultimate tensile strength (1500 to 2000 MPa) in the press-hardened condition. Owing to the high specific strength of press-hardened steels and their high flexibility in part design, they are widely used for automotive crashworthy components such as B-pillars, A-pillars, and door rings. Typically, press-hardened steel consists of a ferritic-pearlitic structure in the as-received condition, and is then transformed to a fully martensitic structure when austenitized at high temperature and subsequently cooled to ambient temperature during press hardening with water-cooled dies at a critical cooling rate of about 30° C./s. Press-hardened steel has been increasingly employed by the automotive industry with various forms of corrosion-resisting alloy coatings, such as Al—Si, Zn, and Zn—Ni; among them, Al-Si coating has better corrosion and high temperature oxidation resistance capability.

A known method for the fabrication of welded steel parts consists of procuring at least two steel sheets as described in publication EP 971044, butt welding these two sheets to obtain a welded blank, optionally cutting this welded blank, then heating the welded blank before performing a hot forming operation to impart to the steel part the shape required for its application.

One known welding technology is laser beam welding. This technology has advantages in terms of flexibility, quality and productivity compared to other welding technologies such as seam welding or arc welding

### SUMMARY OF THE INVENTION

During the welding operation, however, the aluminum-based pre-coating consisting of an intermetallic alloy layer which is in contact with the steel substrate, topped by a layer of metal alloy, is diluted with the steel substrate within the weld metal zone, which is the zone that is in the molten state during the welding operation and which solidifies after this welding operation, forming the bond between the two sheets.

In the range of aluminum contents of the pre-coating, the aluminum, which is an alphagene element in solid solution in the matrix, prevents the transformation into austenite which occurs during the step preceding the stamping. Consequently, it is no longer possible to obtain martensite during the cooling after the hot forming and the welded seam contains ferrite. The weld metal zone then exhibits a hardness and mechanical strength which are less than those of the two adjacent sheets, which can lead to critical failure of the final part in the weld zone.

A parallel can be made between the above described adverse interaction of the Al based coating of hot stamping steels and the laser welding operation with the problems posed by the laser welding of third generation Zn based pre-coated cold stamping steels. Such third-generation steels, presenting very high strength and high formability, used to make complex structural parts by cold stamping, are subject to liquid metal embrittlement during laser welding. This is due to the interaction between the liquified zinc of the pre-coating and the retained austenite of the substrate.

Several solutions have been developed to prevent the aforementioned adverse interaction. For example, publication EP2007545 describes a solution which consists of eliminating, at the level of the periphery of the sheets destined to be subjected to the welding operation, the superficial layer of metal alloy, leaving only the layer of intermetallic alloy. The removal can be performed by brushing or by laser beam. The intermetallic alloy layer is preserved to guarantee the corrosion resistance and to prevent the phenomena of decarburization and oxidation during the heat treatment that precedes the forming operation.

to It is an object of the present invention to provide a novel solution to base metal/pre coating interaction during laser welding. It aims at providing a pre-coated steel sheet which is easy to manufacture, and which increases the mechanical strength of the weld metal zone of a welded steel part prepared from said pre-coated sheet.

The present disclosure provides a method for the fabrication of a pre-coated steel sheet comprising at least the step of applying an additional coating at least at a region at the periphery of at least one of the opposite faces of said pre-coated sheet, said additional coating being selected for increasing the vapor pressure between the pre-coating and said additional coating during a laser welding method up to a critical pressure at which the pre-coating is ejected away from the weld.

The method according to the invention may also have the optional features listed below, considered individually or in combination:
the vaporization temperature of the additional coating is greater than the vaporization temperature of the pre-coating.
the additional coating comprises gammagene elements.
the additional coating comprises carbon and/or nickel.

Finally, the invention also consists of a method for the fabrication of a steel part comprising at least the step of laser welding of at least a first and second pre-coated steel sheets wherein at least a region at the periphery of at least one of the opposite faces of said first and second pre-coated steel sheets has been previously coated with an additional coating selected for increasing the vapor pressure between the pre-coating and said additional coating during the laser welding method up to a critical pression from which the pre-coating is ejected away from the weld.

The method according to the invention may also have the optional features listed below, considered individually or in combination:
the laser welding is a butt laser welding.
the application of the additional coating at least at a region at the periphery of one of the opposite faces of said first and second pre-coated steel sheets, and the welding of said first and second pre-coated steel sheets are performed simultaneously.
the vaporization temperature of the additional coating is greater than the vaporization temperature of the pre-coating.
the additional coating comprises gammagene elements.
the additional coating comprises carbon and/or nickel.

Other characteristics and advantages of the invention will be described in greater detail in the following description.

### BRIEF DESCRIPTION OF THE DRAWINGS

The invention will be better understood by reading the following description, which is provided purely for purposes of explanation and is in no way intended to be restrictive, with reference to:

FIG. 1, which is a perspective and schematic view of the pre-coated steel sheet according to one embodiment of the invention,

FIG. 2, which is a perspective and schematic view of a butt laser welding operation of the method according to one embodiment of the invention,

FIG. 3 is a photography of a butt laser welding operation of two pre-coated steel sheets having a Zn based pre-coating and without additional coating,

FIG. 4 is a photography of a butt laser welding operation of two pre-coated steel sheets having a Zn based pre-coating and for which the periphery of said steel sheets is coated with an additional coating according to the invention,

FIG. 5 is a graph illustrating the total ferrite area percentage in the welded zone as a function of the thickness of the additional coating comprising carbon, including the case without any additional coating,

FIG. 6 is a graph illustrating the aluminum weight percentage in the welded zone as a function of the thickness of the additional coating comprising carbon, including the case without any additional coating,

FIG. 7 is a graph illustrating the carbon weight percentage in the welded zone as a function of the thickness of the additional coating comprising carbon, including the case without any additional coating,

FIG. 8 represents a comparative profile of the ultimate tensile strength of the welded zone issued from a butt laser welding operation of two pre-coated steel sheets for which the periphery of said steel sheets is coated with an additional coating comprising carbon and with an additional coating comprising nickel, as a function of the thickness of the corresponding additional coating, including the case without any additional coating,

FIG. 9 is a photography of a butt laser welding operation of two pre-coated steel sheets having an Al based pre-coating and without additional coating,

FIG. 10 is a photography of a butt laser welding operation of two pre-coated steel sheets having an Al based pre-coating and for which the periphery of said steel sheets is coated with an additional coating according to the invention.

### DETAILED DESCRIPTION

The pre-coated steel sheet of the invention is coated with a metallic coating, generally designed to protect the steel substrate from corrosion. The metallic coating of the pre-coating can be for example Al based, which is commonly used in the case of press-hardening steels. The metallic coating of the pre-coating can be for example Zn based, which is commonly used in the case of cold stamping steels. By Al based, it is meant that the coating contains at least 50% in weight of Al. By Zn based, it is meant that the coating contains at least 50% in weight of Zn.

The pre-coated steel sheet of the invention is coated by immersion in a bath of molten aluminum according to a method called continuous “dip coating” as described in publication EP971044 are provided. The term sheet is used in a broad sense as any strip or object obtained by cutting from a strip, coil or sheet. The aluminum bath which is the object of the dipping operation can also include from 8 to 11% silicon and from 2 to 4% iron. The pre-coating of the pre-coated steel sheet is therefore a metal alloy coating comprising, in percent by weight, between 8 and 11% silicon and between 2 and 4% iron.

The steel constituting the steel substrate of the sheets exhibits the following composition, expressed in percent by weight:

0.10%≤C≤0.5%

0.5%≤Mn≤3%

0.1%≤Si≤1%

0.01%≤Cr≤1%

Ti≤0.2%

Al≤0.1%

S≤0.05%

P≤0.1%

0.0002%≤B≤0.010%,

the balance being iron and unavoidable impurities from processing.

The sheets to be welded to one another can be of identical or different com positions.

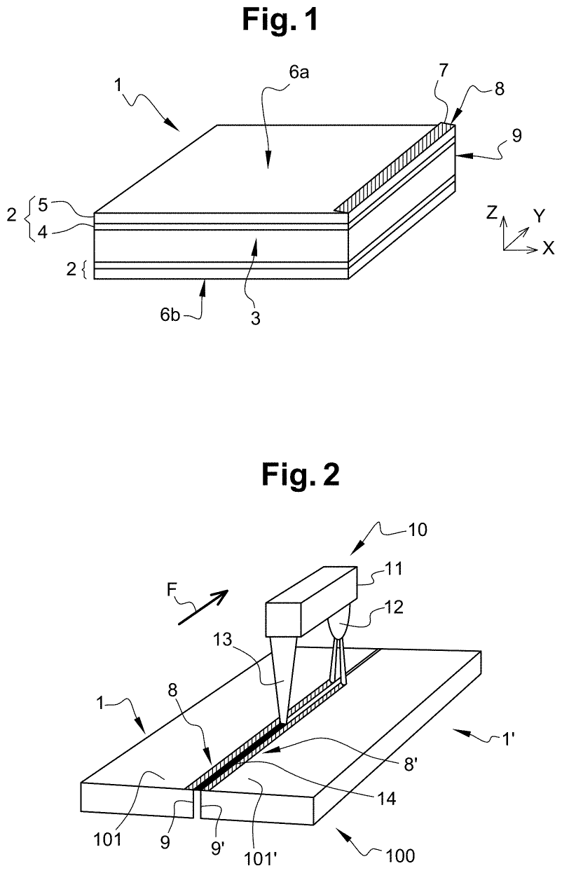

In reference to FIG. 1, the pre-coated steel sheet 1 of the invention comprises the metal alloy coating 2 which is in contact with the steel substrate 3. The metal alloy coating 2 has a first intermetallic alloy layer 4 of the AlSiFe type which is in contact with the surface of the steel substrate 3. This intermetallic alloy layer 4 results from the reaction between the steel substrate 3 and the aluminum bath. This intermetallic alloy layer 4 is topped by a metal alloy layer 5 which forms a surface layer of the pre-coating 2. The pre-coating 2 is present on the two opposite faces 6a, 6b of the sheet 4.

According to the invention, at least a region at the periphery 7 of the top face 6a of the pre-coated steel sheet 1 is coated with an additional coating 8. In reference to FIG. 1 which represents one embodiment of the invention, the additional coating 8 extends along a free edge 9 of the sheet 1. The characteristics of the additional coating 8 will be detailed further.

According to the invention, the additional coating 8 may be applied on the top face 6a or on both faces 6a,6b by application of said additional coating 8 with application means, such as by spin coating, or spray painting or using a paint brush, said application means being well known to the man skilled in the art. The additional coating 8 is applied either in a separate step taking place before the laser welding operation or in the same process step as the laser welding operation according to the representation of FIG. 2.

In reference to FIG. 2, a first sheet 1 and the second sheet 1′ are placed edge to edge which is known as the butt-joint or butt-welding configuration according to conventional laser welding techniques by contact or nearly contact between their respective free edges 9,9′.

FIG. 2 represents part of a laser welding machine 10 comprising a welding head 11 which comprises at least one application means 12 ensuring the application of the additional coating 8,8′ at the periphery of each sheet 1,1′, and further comprises the laser beam 13. During the laser welding operation, a relative movement is ensured between the laser welding machine 10 and the sheets to be welded, to the relative movement of the welding machine 10 follows the welding direction illustrated by the arrow F. The additional coatings 8,8′ are applied on the respective periphery of the pre-coated steel sheet 1,1′ by the application means 12 situated upstream to the laser beam 13. Simultaneously, the laser beam 13 operates the welding along the junction between the steel sheets 1,1′ whose periphery is already coated with the additional coating 8,8′ then forming a weld metal zone 14 connecting the two steel sheets 1,1′ together. Alternatively, the laser beam may be combined with a filler wire not illustrated in FIG. 2. The resulting steel part 100 comprises essentially two plates that will be named base metal 101,101′ joined by the weld metal zone 14.

The welding method is realized under conditions and with equipment well known by the man skilled in the art.

The additional coating 8 is first selected under its own capability considered in conjunction with the pre-coating 2 for increasing the vapor pressure between said pre-coating 2 and said additional coating 8 during the laser welding up to a critical pressure at which the pre-coating 2 is ejected away from the weld. When the pre-coating 2 is of the AlSiFe type, its ejection from the welding zone leads to avoid or at least limit the aluminum content in the weld metal zone, as it will be further detailed.

To provide such ejection, the additional coating 8 has to stay in a state that allows the vapor pressure between the pre-coating 2 and said additional coating 8 to increase enough during the laser welding. For this purpose, preferably, the vaporization temperature of the additional coating 8 is greater than the vaporization temperature of the pre-coating 2 so that the vaporization of the pre-coating 2 due to the temperature increase in the welding zone between the pre-coating 2 and the additional coating 8 can lead to increase the vapor pressure up to a critical pressure wherein the additional coating 8 is ejected alongside part of the pre-coating 2. By considering that the vaporization temperature of the AlSiFe type pre-coating 2 corresponds to the vaporization temperature of about 2520° C. of Aluminum, it is preferred to have an additional coating 8 with a vaporization temperature at least greater than 2720° C.

The additional coating 8 may be preferably also selected to bring gammagene elements in the welding zone. For example, the additional coating 8 advantageously comprises carbon and/or nickel. As carbon has a vaporization temperature of about 3500° C. and nickel has a vaporization temperature of about 2913° C. they are both also possible candidates to allow the sufficient increase of vapor pressure between the pre-coating 2 and the additional coating 8 as explained above. When the additional coating 8 is carbon based, PELCO® Conductive Graphite Isopropanol based can be advantageously used.

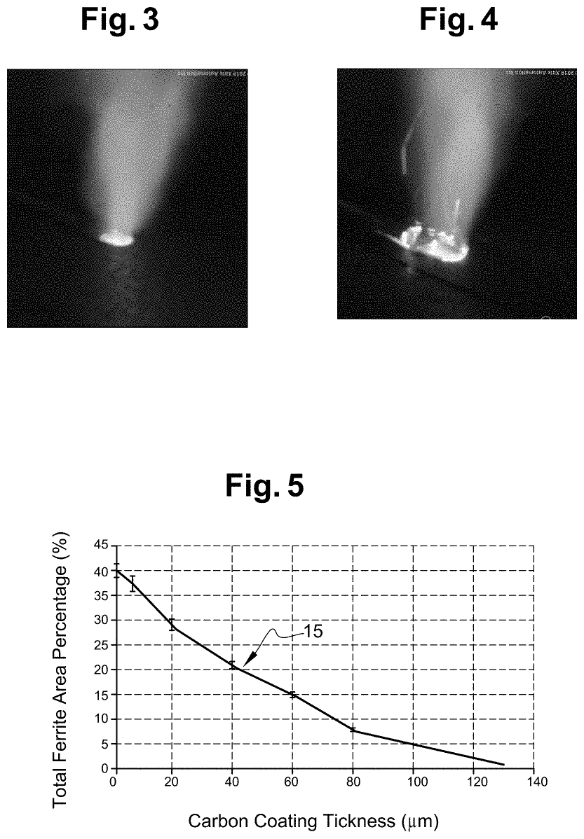

Referring to FIGS. 3, 4 and 9, 10, it can be observed that the laser welding of a pre-coated steel sheet of the invention comprising the additional coating involves material (aluminum) ejection in the form of sparks (FIGS. 4 and 10), compared to the laser welding of a pre-coated steel sheet without additional coating (FIGS. 3 and 9).

According to the invention, the additional coating 8 may be applied along the periphery on one face of the pre-coated steel sheet 1 or on both opposite faces.

When the additional coating 8 is applied on one face of the pre-coated steel sheet 1 and when the additional coating 8 comprises pure nickel, the thickness of said additional coating 8 may be comprised between 15 to 40 μm, preferably between 20 to 30 μm, most preferably of about 25 μm.

When the additional coating 8 is applied on one face of the pre-coated steel sheet 1 and when the additional coating 8 comprises carbon (PELCO® Conductive Graphite Isopropanol based), the thickness of said additional coating 8 may be comprised between 30 to 85 μm, preferably between 35 to 50 μm, most preferably of about 40 μm.

The width of the additional coating 8 is adjusted to cover at least the welding zone. For this purpose, the width of the additional coating 8 may be comprised between 2 mm and 5 mm.

### Example 1

In this example, the additional coating 8 is applied on only one face (top face) of each pre-coated steel sheet 1,1′ intended to be welded together.

Each pre-coated steel sheet 1,1′ is Al—Si coated press-hardened steel (PHS) (USIBOR® 1500).

The chemical composition of the press hardened steel used is given in the Table 1 below.

TABLE 1
Chemical composition of the steel substrate

| C | Mn | P | S | Si | Cu | Ni | Mo | Cr | Co | V | Al | Sn | Ti | N | B | Fe |
|---|---|---|---|---|---|---|---|---|---|---|---|---|---|---|---|---|
| 0.23 | 1.22 | 0.013 | 0.001 | 0.27 | 0.02 | 0.037 | 0.02 | 0.20 | 0.008 | 0.008 | 0.039 | 0.02 | 0.037 | 0.0054 | 0.0032 | Bal. |

The pre-coating 2 of Al—Si comprises πweight % of Aluminum and 8 weight % of Silicon and 2% Iron. The thickness of the pre-coating 2 is of about 15 micrometers.

Referring to FIGS. 5, 6 and 7, the additional coating 8 is an isopropanol based graphite resistive and dry film lubricant coating commercialized under the commercial name PELCO® Conductive Graphite Isopropanol based. In this example, the butt-welding operation was first simulated using a bead on plate type of configuration. In this configuration, instead of using two separate pre-coated sheets which are positioned side by side to be welded (butt-welding configuration), the experiment is performed using a single sheet on which the laser welding operation is simulated by applying the laser beam to the surface of the sheet, with and without prior application of the additional coating. Because it uses the same type of Laser and the same material as in the butt-welding process, the bead on plate configuration is a convenient way to simulate the physical phenomena linked to the effect of the energy brought by the laser beam and the interactions between the substrate, the pre coating and the additional coating. Since it does not involve setting up two sheets side by side to be welded, it is simpler to implement than butt welding and therefore convenient to conduct experiments.

The pre-coated steel sheets are welded in a bead on plate configuration using an IPG photonics ytterbium fiber laser system (model: YLS-6000-S2) with a power and a speed of 4 kW and 4 m/min, respectively. A detailed description of the laser weld system is provided in Table 2 below.

TABLE 2
Laser weld system

| Laser | Laser Source | | Laser Head | | Beam | Fiber |
|---|---|---|---|---|---|---|
| Type | Make | Model | Make | Focal Length | Spot Size | Core |
| Ytterbium | IPG | YLS- | Laser | 200 mm | 0.6 mm | 0.3 mm |
| Laser System | Photonics | 6000-S2 | Mechanisms | | Diameter | Diameter |

After welding, the welded sheets are austenitized in a furnace at 930° C. for 5 mins followed by quenching between flat dies.

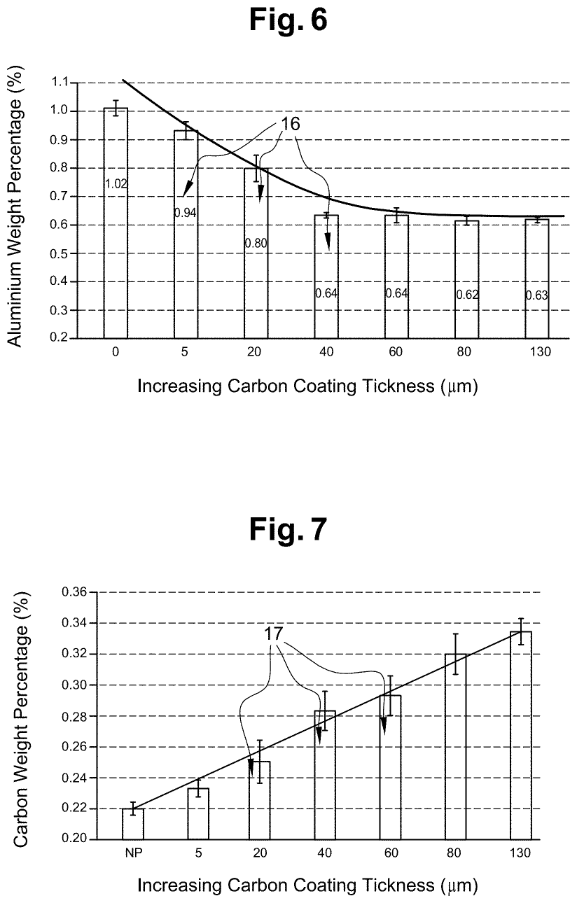

Ferrite content (reference 15 on FIG. 5), aluminum content (reference 16 on FIG. 6) and carbon content (reference 17 on FIG. 7) are measured in the fusion zone by image analysis using Clemex Vision Lite software as a function of the thickness of the carbon additional coating 8.

Referring to FIG. 5, it can be observed that the ferrite area percentage 15 in the weld metal zone is significantly reduced for a carbon coating thickness of 20 μm, and most significantly reduced by 30% for a carbon coating thickness of 40 μm compared to the ferrite area percentage in the weld metal zone when the welded sheets are not coated with the additional coating.

This ferrite area percentage reduction can be explained by the ejection of aluminum contained in the pre-coating 2 of Al—Si during the laser welding. This ejection is confirmed by FIG. 6, where it can be observed that the aluminum weight percentage 16 in the weld metal zone is significantly reduced for a carbon coating thickness of 20 μm, and most significantly reduced by 30% for a carbon coating thickness of 40 μm compared to the aluminum weight percentage in the weld metal zone when the welded sheets are not coated with the additional coating.

Concomitantly, as illustrated on FIG. 7, the carbon weight percentage in the weld metal zone increases with the increase of the carbon coating thickness.

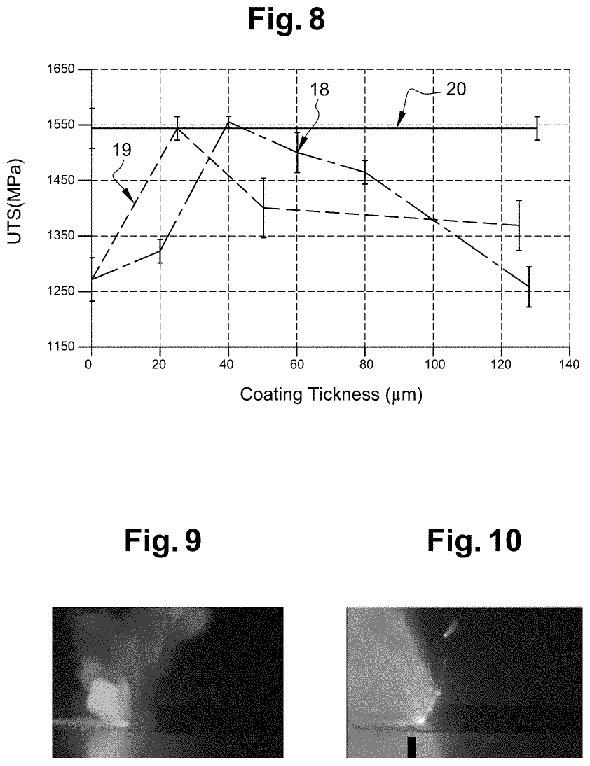

FIG. 8 illustrates a comparative profile of the ultimate tensile strength of the welded zone resulting from a laser welding operation in butt joint configuration of two pre-coated steel sheets of the invention that are both respectively coated with an additional coating of carbon (reference 18) and nickel (reference 19) as a function of the additional coating thickness. Reference 20 represents the ultimate tensile strength of 1543 MPa of the steel substrate.

For an additional coating comprising nickel (reference 19), the ultimate tensile strength reaches a maximum ultimate tensile strength of 1539 MPa for an additional coating thickness of 25 μm, then shifting the failure from the metal weld zone to the base metal. To avoid a systematic failure in the metal weld zone and referring to the shape of the referenced curve 19, the nickel coating thickness may be comprised between 15 to 40 μm, preferably between 20 to 30 μm.

For an additional coating comprising carbon (reference 18), the ultimate tensile strength reaches a maximum ultimate tensile strength of 1555 MPa for an additional coating thickness of 40 μm, then shifting the failure from the metal weld zone to the base metal. To avoid a systematic failure in the metal weld zone and referring to the shape of the referenced curve 18, the carbon coating thickness may be comprised between 30 to 85 μm, preferably between 35 to 50 μm.

### Example 2

In this example, the pre-coating is a Zn based pre-coating typically used in the case of cold stamping steels. The experiment was performed using a butt welding configuration. The additional coating used is a Ni-based coating. FIG. 9 is a picture of the butt-welding operation performed without the additional coating.

As can be seen, no expulsion of the pre-coating takes place. On the other hand, in the case of sheets having the additional coating applied to the edges to be welded, as can be seen on FIG. 10, pre-coating expulsion occurs in the form of sparks.

In summary, pre-coated steel sheets have been successfully joined by butt joint laser welding by introducing a carbon or nickel additional coating that has been coated onto at least one face of a region of the periphery of each pre-coated steel sheet prior to welding. Aluminum content in the weld metal zone is reduced to below a critical value required to form a soft delta-ferrite phase; therefore, the delta-ferrite phase formation in the weld pool is suppressed/eliminated. The weld metal zone microstructure is transformed from ferritic-martensitic dual phase structure to a completely martensitic structure which exhibits high mechanical properties (both microhardness and tensile properties) compared to the un-welded base metal in the press-hardened condition. The ultimate tensile strength is obtained similar to the un-welded base metal; the fracture path shifted from the weld metal zone to the base metal. The welded joint strength and ductility after hot stamping the pre-coated steel parts are enhanced to the level of the un-welded base press-hardened steels.

What is claimed is:

1-28. (canceled)

29. A method for the fabrication of a pre-coated steel sheet having a steel substrate and a metal alloy coating in contact with a surface of the steel substrate, the method comprising:
applying on top of the metal alloy coating by spin coating or spray painting or using a paint brush, an additional coating at least at a region at a periphery of at least one of opposing faces of the pre-coated sheet, the additional coating having a vaporization temperature greater than the metal alloy coating and being selected for increasing the vapor pressure between the metal alloy coating and the additional coating during a laser butt-welding method up to a critical pressure, the pre-coating being ejected away from the weld at the critical pressure.

30. The method as recited in claim 29 wherein the additional coating comprises gammagene elements.

31. The method as recited in claim 29 wherein the additional coating includes carbon or nickel.

32. A method for the fabrication of a steel part comprising:
laser butt-welding of first and second pre-coated steel sheets, each comprising a steel substrate and a metal alloy coating in contact with a surface of the steel substrate, wherein at least a region at the periphery of at least one of opposing faces of the first and the second pre-coated steel sheets has been previously coated with an additional coating applied on top of the metal alloy coating by spin coating, or spray painting or using a paint brush, the additional coating having a vaporization temperature greater than the metal alloy coating and being selected for increasing the vapor pressure between the metal alloy coating and the additional coating during the laser butt-welding method up to a critical pressure, the pre-coating being ejected away from the weld at the critical pressure.

33. The method as recited in claim 32 wherein application of the additional coating at least at a region at the periphery of one of the opposite faces of the first and second pre-coated steel sheets, and the laser butt-welding of the first and second pre-coated steel sheets are performed simultaneously.

34. The method as recited in claim 32 wherein the additional coating comprises gammagene elements.

35. The method as recited in claim 32 wherein the additional coating includes carbon or nickel.
